(19) United States
(12) Patent Application Publication
(10) Pub. No.: US 2025/0167933 A1
(43) Pub. Date: May 22, 2025

(54) METHOD AND APPARATUS FOR CODEBOOK TRANSMISSION, METHOD AND APPARATUS FOR RECEPTION AND DETERMINATION, COMMUNICATION APPARATUS AND STORAGE MEDIA

(71) Applicant: Beijing Xiaomi Mobile Software Co., Ltd., Beijing (CN)

(72) Inventor: Qun ZHAO, Beijing (CN)

(73) Assignee: Beijing Xiaomi Mobile Software Co., Ltd., Beijing (CN)

(21) Appl. No.: 18/841,109

(22) PCT Filed: Feb. 25, 2022
(86) PCT No.: PCT/CN2022/078085

§ 371 Date: Aug. 23, 2024

(51) Int. Cl. H04L 1/1867; H04L 1/1829; H04L 5/00

(52) U.S. Cl. CPC H04L 1/1887; H04L 1/1861; H04L 5/0044

(57) ABSTRACT

A method, apparatus and computer readable medium for codebook transmission in a communication network. The codebook is transmitted by: determining a configured group radio network temporary identity (G-RNTI); generating a codebook corresponding to the G-RNTI; obtaining a target codebook by carrying out a bundling operation on bits in the codebook; and sending the target codebook to a network device.

### CROSS-REFERENCE TO RELATED APPLICATIONS

The present application is a U.S. National Stage of International Application No. PCT/CN2022/078085, filed on Feb. 25, 2022, the contents of all of which are incorporated herein by reference in their entirety for all purposes.

### BACKGROUND OF THE INVENTION

A current codebook is generated according to a radio network temporary identity (RNTI). Since some terminals support a plurality of RNTIs, a plurality of codebooks will be generated and reported to a base station, causing an excessive uplink overhead.

### SUMMARY OF THE INVENTION

In view of this, examples of the disclosure provide a method for codebook transmission, a method for reception and determination, an apparatus for codebook transmission, an apparatus for reception and determination, a communication apparatus, and a computer-readable storage medium, so as to solve the technical problems in the related art.

According to a first aspect of an example of the disclosure, a method for codebook transmission is provided. The method is performed by a terminal and includes: determining a configured group-radio network temporary identity (G-RNTI); generating a codebook corresponding to the G-RNTI; obtaining a target codebook by carrying out a bundling operation on bits in the codebook; and sending the target codebook to a network device.

According to a second aspect of an example of the disclosure, a method for reception and determination is provided. The method is performed by a network device and includes: receiving a target codebook sent by a terminal, where the target codebook is obtained by carrying out a bundling operation on bits in a codebook corresponding to at least one G-RNTI; and determining, according to bits in the target codebook, whether the terminal successfully decodes a PDSCH candidate corresponding to each bit in the codebook corresponding to the at least one G-RNTI.

According to an example of the disclosure, a communication apparatus is provided. The communication apparatus includes: one or more processors and a memory, and the one or more processors are collectively configured to: determine a configured group-radio network temporary identity (G-RNTI); generate a codebook corresponding to the G-RNTI; obtain a target codebook by carrying out a bundling operation on bits in the codebook; and send the target codebook to a network device.

According to an example of the disclosure, a communication apparatus is provided. The communication apparatus includes: one or more processors; and a memory configured to store a computer program. When the computer program is executed by the one or more processors, the communication apparatus performs the method for reception and determination.

According to an example of the disclosure, a non-transitory computer-readable storage medium is provided. The non-transitory computer-readable storage medium is configured to store a computer program. When the computer program is executed by one or more processors, the one or more processors collectively perform the method for codebook transmission.

According to an example of the disclosure, a non-transitory computer-readable storage medium is provided. The non-transitory computer-readable storage medium is configured to store a computer program. When the computer program is executed by one or more processors, the one or more processors collectively perform the method for reception and determination.

According to examples of the disclosure, after determining the configured G-RNTI and generating a codebook corresponding to each G-RNTI, a terminal can obtain a target codebook (or referred to as a final codebook) by carrying out the bundling operation on the bits in the codebook, and then send the obtained target codebook to the network device.

### BRIEF DESCRIPTION OF DRAWINGS

In order to describe technical solutions in examples of the disclosure more clearly, accompanying drawings required to be used in descriptions of the examples will be briefly introduced below. Apparently, the accompanying drawings in the following descriptions show merely some examples of the disclosure. Those of ordinary skill in the art would also be able to derive other accompanying drawings according to these accompanying drawings without making creative efforts.

FIG. 1 is a schematic flow diagram of a codebook transmission method according to an example of the disclosure.

FIG. 2A is a schematic flow diagram of another codebook transmission method according to an example of the disclosure.

FIG. 2B is a schematic diagram of a bundling operation according to an example of the disclosure.

FIG. 3 is a schematic flow diagram of yet another codebook transmission method according to an example of the disclosure.

FIG. 4 is a schematic flow diagram of yet another codebook transmission method according to an example of the disclosure.

FIG. 5A is a schematic flow diagram of yet another codebook transmission method according to an example of the disclosure.

FIG. 5B is a schematic diagram of another bundling operation according to an example of the disclosure.

FIG. 6 is a schematic flow diagram of yet another codebook transmission method according to an example of the disclosure.

FIG. 7 is a schematic flow diagram of yet another codebook transmission method according to an example of the disclosure.

FIG. 8 is a schematic diagram of yet another bundling operation according to an example of the disclosure.

FIG. 9 is a schematic flow diagram of yet another codebook transmission method according to an example of the disclosure.

FIG. 10 is a schematic flow diagram of yet another codebook transmission method according to an example of the disclosure.

FIG. 11 is a schematic flow diagram of a reception and determination method according to an example of the disclosure.

FIG. 12 is a schematic flow diagram of another reception and determination method according to an example of the disclosure.

FIG. 13 is a schematic flow diagram of yet another reception and determination method according to an example of the disclosure.

FIG. 14 is a schematic flow diagram of yet another reception and determination method according to an example of the disclosure.

FIG. 15 is a schematic flow diagram of yet another reception and determination method according to an example of the disclosure.

FIG. 16 is a schematic flow diagram of yet another reception and determination method according to an example of the disclosure.

FIG. 17 is a schematic flow diagram of yet another reception and determination method according to an example of the disclosure.

FIG. 18 is a schematic block diagram of a codebook transmission apparatus according to an example of the disclosure.

FIG. 19 is a schematic block diagram of a reception and determination apparatus according to an example of the disclosure.

FIG. 20 is a schematic block diagram of an apparatus for reception and determination according to an example of the disclosure.

FIG. 21 is a schematic block diagram of an apparatus for codebook transmission according to an example of the disclosure.

### DETAILED DESCRIPTION OF THE INVENTION

Technical solutions of examples of the disclosure will be clearly and completely described in combination with accompanying drawings of the examples of the disclosure. Apparently, the described examples are merely some examples rather than all examples of the disclosure. Based on examples of the disclosure, all other examples obtained by those of ordinary skill in the art without making creative efforts fall within the scope of protection of the disclosure.

Terms used in examples of the disclosure are merely to describe particular examples, and are not intended to limit examples of the disclosure. Singular forms such as “a,” “an,” “the” and “this” used in examples of the disclosure and the appended claims are also intended to include plural forms, unless otherwise clearly stated in the context. It should also be understood that the term “and/or” used here refers to and includes any or all possible combinations of one or more of associated listed items.

It should be understood that although terms “first,” “second,” “third,” etc. may be employed in examples of the disclosure to describe all types of information, such information should not be limited to these terms. These terms are merely used for distinguishing the same type of information from each other. For instance, a first indication can also be referred to as a second indication, and similarly, the second indication can also be referred to as the first indication, without departing from the scope of examples of the disclosure. Depending on the context, the word “if” as used here can be interpreted as “when,” “in a case that” or “in response to determining”.

For purposes of concision and ease of understanding, terms “greater than” or “less than” and “higher than” or “lower than” are used here to represent size relations. Those skilled in that art can understand that the term “greater than” also encompasses the meaning of “greater than or equal to,” the term “less than” also encompasses the meaning of “less than or equal to,” the term “higher than” also encompasses the meaning of “higher than or equal to,” and the term “lower than” also encompasses the meaning of “lower than or equal to”.

The disclosure relates to the field of communication technology, and particularly relates to a codebook transmission method, a reception and determination method and apparatus, a communication apparatus, and a non-transitory computer-readable storage medium.

By carrying out the bundling operation on the bits in the codebook, the obtained target codebook can include fewer bits than the codebook before the bundling operation. Thus, compared with transmitting a plurality of codebooks corresponding to a plurality of G-RNTIs to the network device, transmitting the target codebook to the network device can save uplink resources.

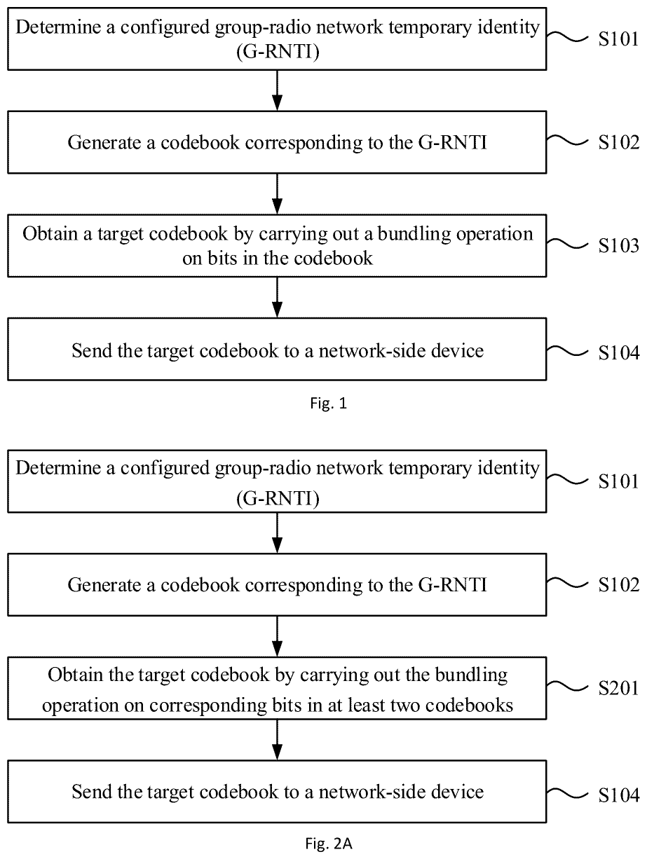

FIG. 1 is a schematic flow diagram of a codebook transmission method according to an example of the disclosure. The codebook transmission method shown in the example may be performed by a terminal. The terminal includes but is not limited to a mobile phone, a tablet computer, a wearable device, a sensor, an internet of things device (such as a narrow band internet of things (NB-IoT) device, a machine type communication (MTC) device, and an enhanced machine type communication (eMTC) device), and other communication apparatuses. The terminal may be in communication with a network device. The network device includes but is not limited to a network device in a 4G, 5G, 6G, and other communication systems, such as a base station and a core network.

As shown in FIG. 1, the codebook transmission method may include steps as follows:
S101: Determine a configured group-radio network temporary identity (G-RNTI).
S102: Generate a codebook corresponding to the G-RNTI.
S103: Obtain a target codebook by carrying out a bundling operation on bits in the codebook.
S104: Send the target codebook to a network device.

In an example, the network device may configure one or more G-RNTIs for the terminal. The terminal may generate a corresponding codebook according to each G-RNTI. The codebook may include a Type-1 codebook.

For instance, in a case that the terminal is configured with a plurality of G-RNTIs, the terminal generates a corresponding Type-1 codebook according to each G-RNTI such that a plurality of codebooks can be obtained. One codebook may include one or more bits, and 1 bit corresponds to one M_ac, where M_ac may represent a physical downlink shared channel (PDSCH) candidate. A bit corresponding to the PDSCH candidate may serve as hybrid automatic repeat request (HARQ) information configured to indicate whether the PDSCH candidate is successfully received (received and successfully decoded).

For instance, in a case that a value of the bit is 1, the bit is configured to indicate a hybrid automatic repeat request-acknowledgment (HARQ-ACK). In a case that the value of the bit is 0, the bit is configured to indicate a hybrid automatic repeat request-negative acknowledgment (HARQ-NACK).

It should be noted that a relation between the value and an indicated content of the bit can be adjusted according to requirements, which is not limited to the above cases. For instance, in a case that the value of the bit is 0, the bit may indicate the HARQ-ACK. In a case that the value of the bit is 1, the bit may indicate the HARQ-NACK. The following examples are illustratively described mainly in cases that the value of the bit is 1 and the bit indicates the HARQ-ACK, and the value of the bit is 0 and the bit indicates the HARQ-NACK.

In a case that the terminal is configured with a plurality of G-RNTIs, since a plurality of codebooks are required to be generated and uplink-sent to the network device, a large number of uplink resources are occupied. Moreover, excessive uplink overhead is likely to deteriorate a physical uplink control channel (PUCCH) performance.

According to examples of the disclosure, after determining the configured G-RNTI and generating a codebook corresponding to each G-RNTI, a terminal can obtain a target codebook (or referred to as a final codebook) by carrying out the bundling operation on the bits in the codebook, and then send the obtained target codebook to the network device.

By carrying out the bundling operation on the bits in the codebook, the obtained target codebook can include fewer bits than the codebook before the bundling operation. Thus, compared with transmitting a plurality of codebooks corresponding to a plurality of G-RNTIs to the network device, transmitting the target codebook to the network device can save uplink resources.

In an example, the bundling operation includes a logical AND operation.

The bundling operation may be carried out on bits in different codebooks, or may be carried out on different bits in the same codebook. For instance, the logical AND operation may be carried out on a plurality of bits subjected to the bundling operation. That is, an obtained result is 1 in a case that values of these bits are all 1 and is 0 as long as a value of any one of these bits is 0.

Through the logical AND operation, a value can be obtained according to values of a plurality of bits such that a number of bits in a target codebook finally obtained can be effectively reduced.

Two examples in which the bundling operation is carried out on bits in different codebooks and the bundling operation is carried out on bits in the same codebook will be mainly illustratively described below.

FIG. 2A is a schematic flow diagram of another codebook transmission method according to an example of the disclosure. As shown in FIG. 2A, the steps of obtaining a target codebook by carrying out a bundling operation on bits in the codebook include:
S201: Obtain the target codebook by carrying out the bundling operation on corresponding bits in at least two codebooks.

In an example, the bundling operation may be carried out on corresponding bits in at least two codebooks. The corresponding bits refer to bits having the same order positions in different codebooks.

For instance, with three codebooks as an instance, the terminal generates codebook 1 according to G-RNTI1, generates codebook 2 according to G-RNTI2 and generates codebook 3 according to G-RNTI3. Numbers n of bits included in the three codebooks are the same, and n=10.

FIG. 2B is a schematic diagram of a bundling operation according to an example of the disclosure.

As shown in FIG. 2B, codebook 1 is {1110110111}, codebook 2 is {01111111111} and codebook 3 is {1111111110}. The bundling operation may be carried out on an ith bit in codebook 1, an ith bit in codebook 2 and an ith bit in codebook 3. An obtained value is 0 and serves as a value of an ith bit in the target codebook, where i is an integer greater than or equal to 1 and less than or equal to n. Then, the target codebook obtained by carrying out the bundling operation is {0110110110}.

It can be seen that according to the example, a target codebook can be obtained by carrying out a bundling operation on at least two codebooks. Moreover, a number of the bits included in the target codebook is less than a sum of numbers of bits included in the at least two codebooks. Thus, compared with transmitting at least two codebooks before the bundling operation, transmitting the target codebook to the network device by the terminal can effectively reduce occupation of uplink resources.

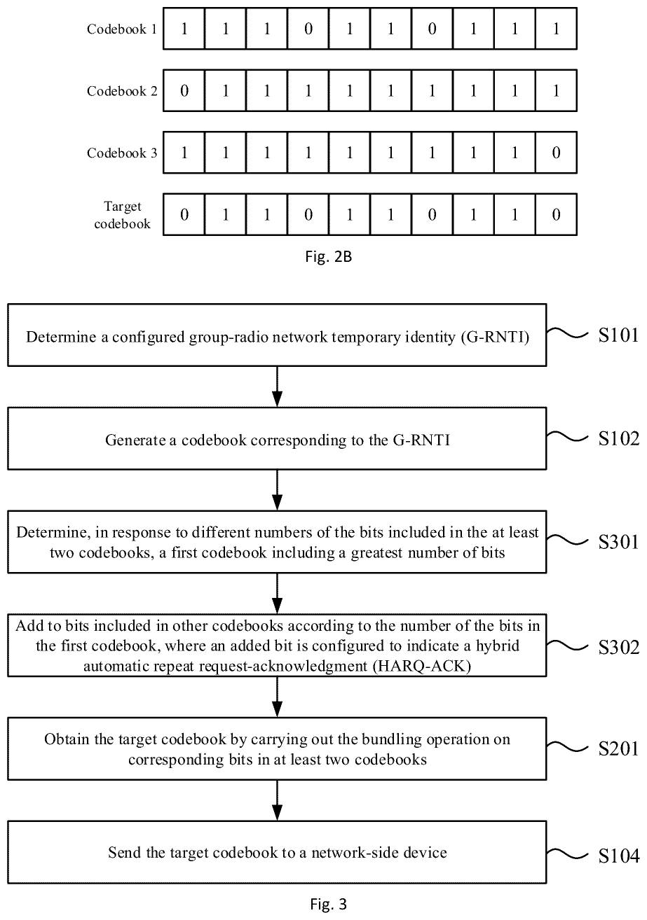

FIG. 3 is a schematic flow diagram of yet another codebook transmission method according to an example of the disclosure. As shown in FIG. 3, the method further includes:
S301: Determine, in response to different numbers of the bits included in the at least two codebooks, a first codebook including a greatest number of bits.
S302: Add to bits included in other codebooks according to the number of the bits in the first codebook, where an added bit is configured to indicate a hybrid automatic repeat request-acknowledgment (HARQ-ACK).

Numbers of bits included in three codebooks shown in FIG. 2B are the same. Thus, all bits included in each codebook have corresponding bits with respect to bits in other codebooks, and the bundling operation can be carried out on the corresponding bits.

However, in some cases, at least two codebooks required to undergo the bundling operation include different numbers of bits. In this case, in an example, a first codebook including a greatest number of bits of at least two codebooks may be determined first, and then a second codebook including a different number of bits from the first codebook is determined. Thus, a second number of the bits included in the second codebook is less than a first number of the bits included in the first codebook.

A bit may be added for the second codebook. For instance, bits included in other codebooks are added to according to the number of the bits in the first codebook, such that the second number is added to the first number. For instance, the first number is 10, the second number is 8, and then 2 bits may be added for the second codebook. Accordingly, it can be ensured that numbers of bits included in the second codebook after bit addition and the first codebook are the same, such that the bits in the second codebook all have corresponding bits with respect to the bits in the first codebook, and the bundling operation can be carried out on the corresponding bits.

The added bit may be set before, after or between the bits originally included in the second codebook according to requirements, and can be specifically set according to requirements.

In an example, the added bit may be configured to indicate the HARQ-ACK. Since the second codebook originally does not include the added bit, the added bit does not correspond to a PDSCH candidate for the second codebook. If this bit is configured to indicate the HARQ-NACK, a result obtained by carrying out the bundling operation will be adversely affected.

For instance, codebook 1 is {1110110111} and codebook 4 is {01101101}. In cases of codebook 1 and codebook 4, if two bits are added after codebook 4, and these two bits are configured to indicate the HARQ-NACK, codebook 4 is {0110110100}. After the bundling operation is carried out on the bits in codebook 1 and codebook 4, the obtained target codebook is {0110110100}. That is, last two bits are 0.

However, in fact, last two bits of codebook 1 are 1 and indicate the HARQ-ACK. That is, the terminal successfully decodes PDSCH candidates corresponding to these two bits and obtains a PDSCH. However, since last two bits of the target codebook are 0, the network device will mistakenly deem that the terminal does not successfully decode the PDSCH candidates corresponding to these two bits and obtain the PDSCH, resulting in mistaken retransmission.

According to the example, codebook 4 after addition is {0110110111}. The target codebook obtained after the bundling operation is carried out on the bits in codebook 1 and codebook 4 is {0110110111}. That is, last two bits are 1. Accordingly, it can be ensured that the network device can accurately determine, according to the target codebook, that the terminal successfully decodes the PDSCH candidates corresponding to the last two bits and obtains the PDSCH, and mistaken retransmission is avoided.

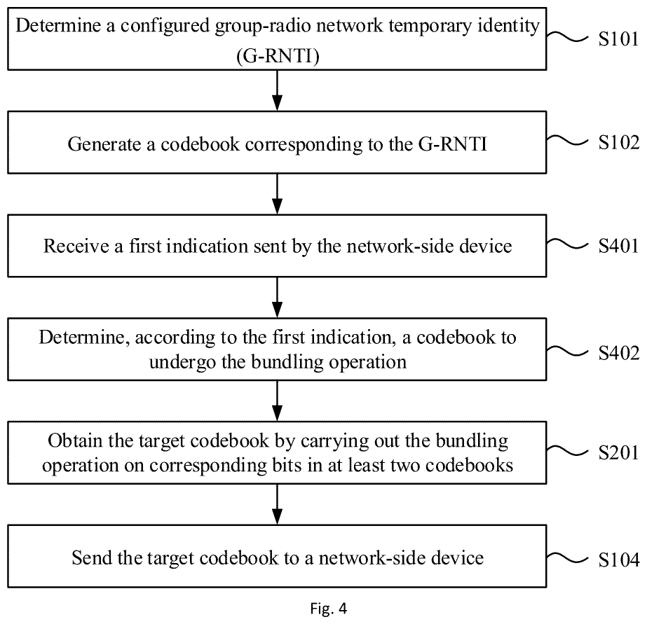

FIG. 4 is a schematic flow diagram of yet another codebook transmission method according to an example of the disclosure. As shown in FIG. 4, the method further includes:
S401: Receive a first indication sent by the network device.
S402: Determine, according to the first indication, a codebook to undergo the bundling operation.

In an example, the network device may send a first indication to the terminal to indicate a codebook to undergo a bundling operation. For instance, the first indication sent to the terminal includes the G-RNTI corresponding to the codebook to undergo a bundling operation, such that the terminal determines that a bundling operation is required to be carried out on the codebook corresponding to the G-RNTI indicated by the first indication, and no bundling operation is carried out on codebooks corresponding to other G-RNTIs. Accordingly, the network device can flexibly control the bundling operation such that real-time requirements can be satisfied.

For instance, in cases of codebook 1, codebook 2 and codebook 3 mentioned above, the network device may instruct, by a first indication, the terminal to carry out a bundling operation on codebook 1 and codebook 2. The terminal may carry out a bundling operation on bits in codebook 1 and codebook 2 and obtain a target codebook, and then send the target codebook and codebook 3 to the network device.

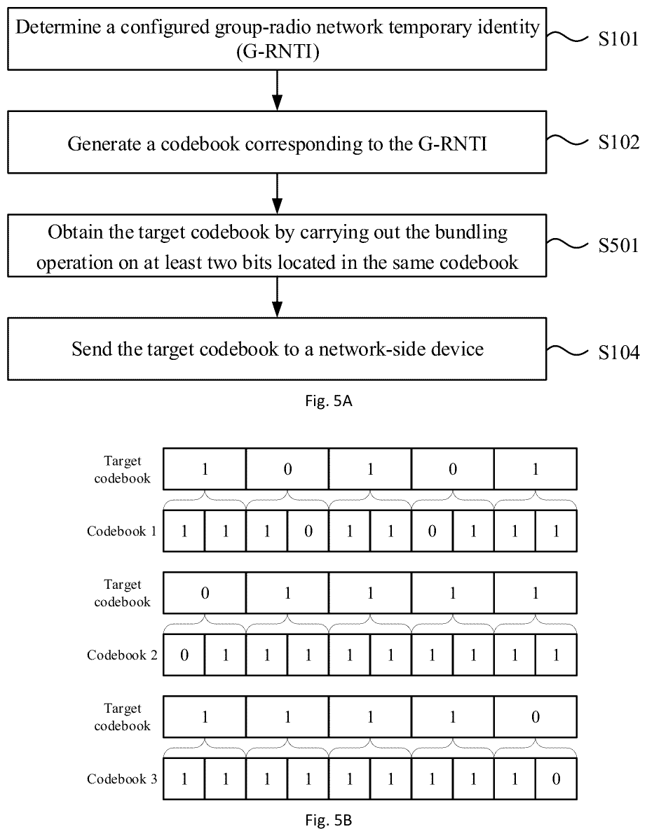

FIG. 5A is a schematic flow diagram of yet another codebook transmission method according to an example of the disclosure. As shown in FIG. 5A, the steps of obtaining a target codebook by carrying out a bundling operation on bits in the codebook include:
S501: Obtain the target codebook by carrying out the bundling operation on at least two bits located in the same codebook.

In an example, a bundling operation may be carried out on at least two bits located in the same codebook to obtain the target codebook. The at least two bits may include bits that are adjacent in the codebook, and may also include bits that are not adjacent in the codebook. The following examples mainly provide exemplary descriptions for a case that the at least two bits include bits that are adjacent in the codebook.

FIG. 5B is a schematic diagram of another bundling operation according to an example of the disclosure.

As shown in FIG. 5B, still with codebook 1, codebook 2 and codebook 3 in the above example as an instance, codebook 1 is {1110110111}, codebook 2 is {01111111111} and codebook 3 is {1111111110}.

For instance, S501 may be executed on the 3 codebooks such that 3 target codebooks can be obtained. A bundling operation may be carried out on every N bits of bits in a codebook, where N may be understood as granularity of the bundling operation.

For instance, in a case of N=2, a bundling operation may be carried out on a 1st bit and a 2nd bit of codebook 1, and an obtained value is 1. A bundling operation is carried out on a 3rd bit and a 4th bit, and an obtained value is 0. A bundling operation is carried out on a 5th bit and a 6th bit, and an obtained value is 1. A bundling operation is carried out on a 7th bit and an 8th bit, and an obtained value is 0. A bundling operation is carried out on a 9th bit and a 10th bit, and an obtained value is 1.

Thus, target codebook {10101} corresponding to codebook 1 is obtained. Similarly, target codebook {01111} corresponding to codebook 2 and target codebook {11110} corresponding to codebook 3 can be obtained. Further, the 3 obtained target codebooks may be sent to the network device.

It can be seen that according to the example, the target codebook obtained by carrying out the bundling operation on at least two bits located in the same codebook includes fewer bits than the codebook before the bundling operation. Thus, compared with transmitting the codebooks before the bundling operation, transmitting the target codebook to the network device by the terminal can effectively reduce occupation of uplink resources.

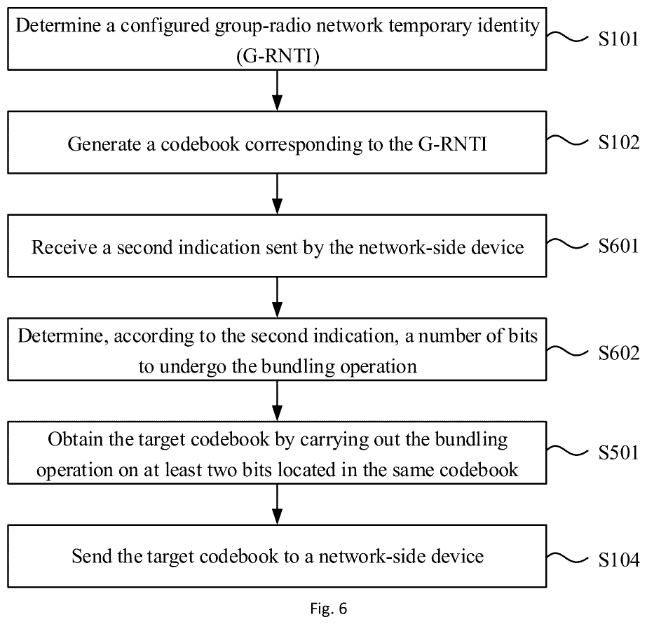

FIG. 6 is a schematic flow diagram of yet another codebook transmission method according to an example of the disclosure. As shown in FIG. 6, the method further includes:
S601: Receive a second indication sent by the network device.
S602: Determine, according to the second indication, a number of bits to undergo the bundling operation.

In an example, the network device may send a second indication to the terminal to indicate a number of bits to undergo a bundling operation, which can also be described as granularity. Thus, the terminal can determine a number of bits to undergo a bundling operation according to the indication of the network device. Accordingly, the network device can flexibly control the bundling operation such that real-time requirements can be satisfied.

For instance, if the second indication sent to the terminal indicates that a number of bits to undergo a bundling operation is 2, the terminal may carry out the bundling operation on bits in the codebook according to N=2 and an example shown in FIG. 5B.

For instance, if the second indication sent to the terminal indicates that a number of bits to undergo a bundling operation is 5, in a case of codebook 1 mentioned above, the bundling operation may be carried out on a 1st bit to a 5th bit, and an obtained value is 0. The bundling operation may be carried out on a 6th bit to a 10th bit, and an obtained value is 0. Thus, target codebook {00} corresponding to codebook 1 is obtained.

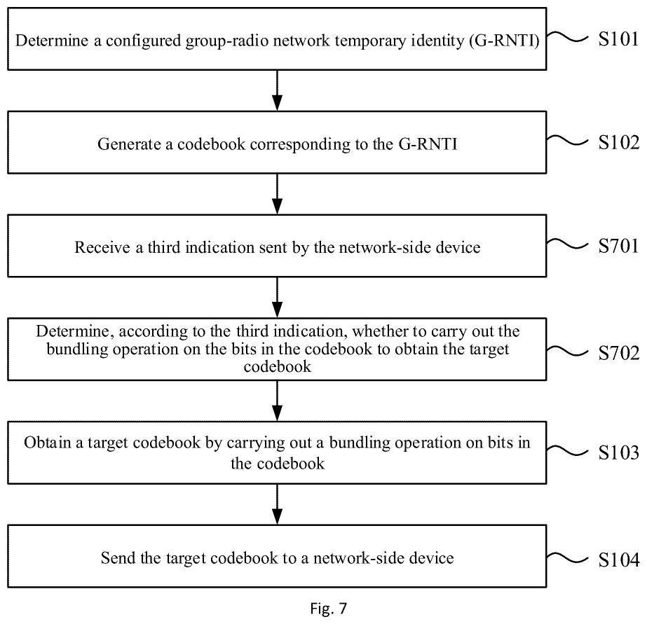

FIG. 7 is a schematic flow diagram of yet another codebook transmission method according to an example of the disclosure. As shown in FIG. 7, the method further includes:
S701: Receive a third indication sent by the network device.
S702: Determine, according to the third indication, whether to carry out the bundling operation on the bits in the codebook.

In an example, the network device may send a third indication to the terminal to control the terminal to enable or disable a function of carrying out a bundling operation on bits in the codebook. For instance, the third indication may be as shown in Table 1 below:

TABLE 1

| Third | Corresponding |
|---|---|
| indication | behavior |
| 0 | Disable a function of carrying out a |
| | bundling operation on a Type-1 |
| | codebook; and a terminal is required |
| | to report a Type-1 codebook |
| | corresponding to each G-RNTI |
| 1 | Enable a function of carrying out a |
| | bundling operation on a Type-1 |
| | codebook; and a terminal carries out |
| | a bundling operation on a codebook |
| | and reports the obtained target |
| | codebook |

As shown in Table 1, the third indication may include 1 bit. In a case that a value of the bit is 0, the bit can instruct the terminal to disable the function of carrying out the bundling operation on the bits in the codebook. In a case that the value of the bit is 1, the bit can instruct the terminal to enable the function of carrying out the bundling operation on the bits in the codebook.

For instance, the network device instructs, by the third indication information, the terminal to enable the function of carrying out the bundling operation on the bits in the codebook. Then, the terminal may carry out the bundling operation on the bits in the codebook according to the above example, and send a target codebook obtained after the bundling operation to the network device.

For instance, the network device instructs, by the third indication information, the terminal to disable the function of carrying out the bundling operation on the bits in the codebook. Then, the terminal does not carry out the bundling operation on the bits in the codebook, but directly sends a codebook corresponding to each G-RNTI to the network device.

Accordingly, the network device can flexibly control whether the terminal carries out the bundling operation such that real-time requirements can be satisfied.

It should be noted that the third indication information may be carried in the same information as the first indication information in the above example, carried in the same information as the second indication information in the above example, or independently carried in one piece of information. Similarly, the first indication information and the second indication information may also be carried in the same information, or carried in different information. Information configured to carry the first indication information, the second indication information and the third indication information includes but is not limited to a radio resource control (RRC) signaling.

For instance, with a case that the first indication is carried in the RRC signaling as an instance, the RRC signaling may include 2 bits, and 4 cases may be indicated.

For instance, 00 indicates case 1 that a bundling operation is carried out on codebooks corresponding to G-RNTI1, G-RNTI2 and G-RNTI3;
01 indicates case 2 that a bundling operation is carried out on codebooks corresponding to G-RNTI1 and G-RNTI2;
10 indicates case 3 that a bundling operation is carried out on codebooks corresponding to G-RNTI1 and G-RNTI3; and
11 indicates case 4 that no bundling operation is executed on codebooks corresponding to different G-RNTIs. In this case, the terminal may carry out a bundling operation on at least two bits located in the same codebook to obtain a target codebook through a method shown in Example 5A mentioned above, or carry out no bundling operation Which operation specifically to be executed can be appointed according to requirements.

In an example, the steps of obtaining a target codebook by carrying out a bundling operation on bits in the codebook include:

Determine a target bit indicating a hybrid automatic repeat request-negative acknowledgment (HARQ-NACK) from the bits of the codebook.

Take the target bit as an indication of a hybrid automatic repeat request-acknowledgment (HARQ-ACK) in response to determining that the target bit is set for a target reason, obtain the target codebook by carrying out the bundling operation on the bits in the codebook.

In an example, the target bit configured to indicate the HARQ-NACK in the codebook may represent that the terminal does not successfully receive a PDSCH at a PDSCH candidate corresponding to the target bit. However, for some reasons (referred to as target reasons in the following), the target bit in the codebook is configured to indicate the HARQ-NACK not because that a PDSCH is not successfully received at the PDSCH candidate corresponding to the target bit. Then, a base station cannot accurately determine, according to the target bit, whether the terminal successfully receives the PDSCH at the PDSCH candidate corresponding to the target bit.

Thus, the terminal may take the target bit configured to indicate the HARQ-NACK due to the target reason as an indication of the HARQ-ACK, and then carry out the above bundling operation such that the base station can determine, according to a result of carrying out the bundling operation on the target bit, whether the terminal successfully receives the PDSCH at the PDSCH candidate corresponding to the target bit.

In an example, the target reason includes at least one of:
a reason that no target downlink control information (DCI) is detected, where the target DCI is configured to schedule a target physical downlink shared channel (PDSCH) corresponding to the target bit; or
a reason that a time slot indicated by value K1 in the target DCI is not a time slot for transmitting the HARQ-ACK.

In an example, the terminal expects to receive the PDSCH on the PDSCH candidate corresponding to target bit. In order to receive the PDSCH, it is required to receive target DCI for scheduling the PDSCH. However, in a case that the terminal does not receive the target DCI, the terminal may configure the target bit to indicate the HARQ-NACK. However, the reason is not that the PDSCH is not successfully received at the PDSCH candidate corresponding to the target bit. As a result, the base station cannot accurately determine, according to the target bit, whether the terminal successfully receives the PDSCH at the PDSCH candidate corresponding to the target bit.

In this case, in the example, the target bit is taken as an indication of the HARQ-ACK and then a bundling operation is carried out such that the base station can determine, according to a result of carrying out the bundling operation on the target bit, whether the terminal successfully receives the PDSCH at the PDSCH candidate corresponding to the target bit.

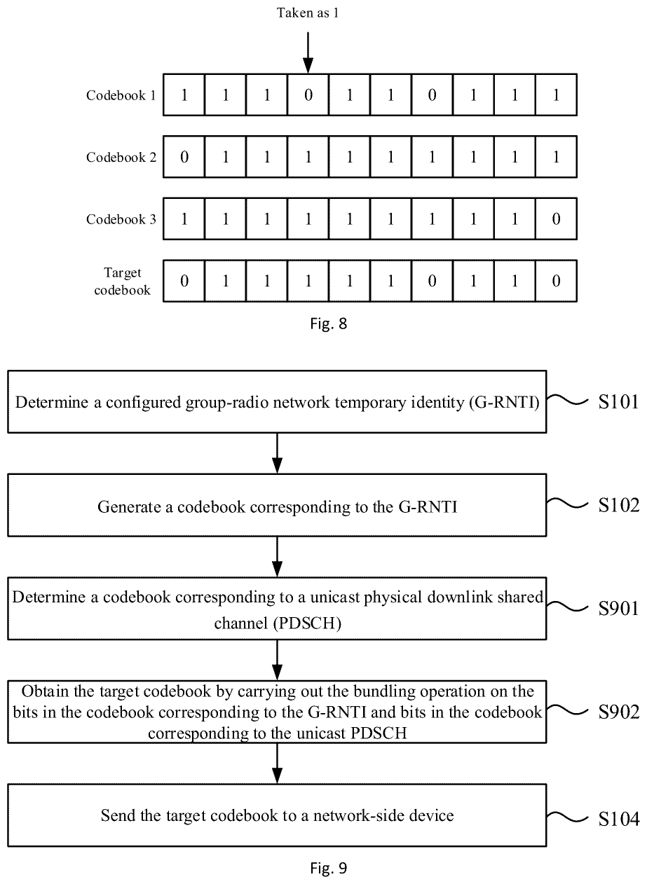

FIG. 8 is a schematic diagram of yet another bundling operation according to an example of the disclosure.

As shown in FIG. 8, still with codebook 1, codebook 2 and codebook 3 in the above example as an instance, a value of a 4th bit in codebook 1 is 0, and the bit is configured to indicate the HARQ-NACK. A reason why the terminal sets the value of this bit as 0 is that the terminal detects no target DCI for scheduling a PDSCH corresponding to this bit (for instance, the network device does not send the DCI for scheduling the PDSCH corresponding to this bit).

If a bundling operation is directly carried out on bits in codebook 2 and codebook 3, an obtained target codebook is {0110110110}, where a 4th bit is 0. After the target codebook is sent to the network device, the network device will deem, according to the value of the 4th bit, that the terminal fails to receive a PDSCH at a PDSCH candidate corresponding to a 4th bit in cases of G-RNTI1, G-RNTI2 and G-RNTI3.

However, in fact, the terminal successfully receives the PDSCH at the PDSCH candidate corresponding to the 4th bit in cases of G-RNTI2 and G-RNTI3, and does not fail to receive the PDSCH at the PDSCH candidate corresponding to the 4th bit in a case of G-RNTI1, but detect no DCI for scheduling the PDSCH corresponding to the 4th bit. It can be seen that the network device will mistakenly determine, according to the target codebook, whether the terminal successfully receives the PDSCH at the PDSCH candidate corresponding to the target bit, and then the network device will carry out mistaken retransmission on the PDSCH.

According to the example, the value of the 4th bit may be taken as 1, that is, taken as an indication of the HARQ-ACK. Then, a bundling operation is carried out on the above bit and bits in codebook 2 and codebook 3, and then an obtained target codebook is {0111110110}. It can be seen that the 4th bit is 1. After the target codebook is sent to the network device, the network device will deem, according to the value of the 4th bit, that the PDSCH is successfully received at the PDSCH candidate corresponding to the 4th bit in cases of G-RNTI1, G-RNTI2 and G-RNTI3. That is, a base station can determine, according to a result of carrying out the bundling operation on the target bit, whether the terminal successfully receives the PDSCH at the PDSCH candidate corresponding to the target bit, and then mistaken retransmission of the PDSCH is avoided.

In an example, DCI (such as the target DCI in the above example) may carry value K1 configured to indicate a time slot for transmitting the HARQ-ACK. No matter whether an HARQ message to be transmitted by the terminal is an HARQ-ACK or HARQ-NACK, in a case that a time slot in which the terminal transmits an HARQ message corresponding to the target bit is not a time slot for transmitting an HARQ-ACK indicated by value K1, the terminal will set the HARQ message as an HARQ-NACK. Thus, the terminal will configure the target bit corresponding to the HARQ message in the codebook to indicate an HARQ-NACK. Further, the base station cannot accurately determine, according to the target bit, whether the terminal successfully receives the PDSCH at the PDSCH candidate corresponding to the target bit.

For instance, still with codebook 1, codebook 2 and codebook 3 as an instance, in the target DCI received by the terminal for the PDSCH candidate corresponding to the 4th bit in codebook 1, the time slot indicated by value K1 for transmitting an HARQ-ACK is a kth time slot. However, the terminal transmits HARQ information corresponding to the 4th bit on a k′th (not equal to kth) time slot, such that the 4th bit is set as an NACK.

If a bundling operation is directly carried out on bits in codebook 2 and codebook 3, an obtained target codebook is {0110110110}, where a 4th bit is 0. After the target codebook is sent to the network device, the network device will deem, according to the value of the 4th bit, that the terminal fails to receive a PDSCH at a PDSCH candidate corresponding to a 4th bit in cases of G-RNTI1, G-RNTI2 and G-RNTI3.

However, in fact, the terminal successfully receives the PDSCH at the PDSCH candidate corresponding to the 4th bit in cases of G-RNTI2 and G-RNTI3, and does not fail to receive the PDSCH at the PDSCH candidate corresponding to the 4th bit in a case of G-RNTI1. Only the time slot for transmitting HARQ information is not the time slot for transmitting an HARQ-ACK indicated by value K1 in the DCI. It can be seen that the network device will mistakenly determine, according to the target codebook, whether the terminal successfully receives the PDSCH at the PDSCH candidate corresponding to the target bit, and then the network device will carry out mistaken retransmission on the PDSCH.

According to the example, the value of the 4th bit may be taken as 1, that is, taken as an indication of the HARQ-ACK. Then, a bundling operation is carried out on the above bit and bits in codebook 2 and codebook 3, and an obtained target codebook is {0111110110}. It can be seen that the 4th bit is 1. After the target codebook is sent to the network device, the network device will deem, according to the value of the 4th bit, that the PDSCH is successfully received at the PDSCH candidate corresponding to the 4th bit in cases of G-RNTI1, G-RNTI2 and G-RNTI3. That is, a base station can determine, according to a result of carrying out the bundling operation on the target bit, whether the terminal successfully receives the PDSCH at the PDSCH candidate corresponding to the target bit, and then mistaken retransmission of the PDSCH is avoided.

FIG. 9 is a schematic flow diagram of yet another codebook transmission method according to an example of the disclosure. As shown in FIG. 9, the method further includes:
S901: Determine a codebook corresponding to a unicast PDSCH.

The steps of obtaining a target codebook by carrying out a bundling operation on bits in the codebook include:
S902: Obtain the target codebook by carrying out the bundling operation on the bits in the codebook corresponding to the G-RNTI and bits in the codebook corresponding to the unicast PDSCH.

In an example, the G-RNTI may be indicated to a terminal carrying out a multicast broadcast service (MBS). A bit in a Type-1 codebook corresponding to the G-RNTI may be configured to indicate whether an MBS PDSCH is successfully received.

The object subjected to the bundling operation in the example may not be limited to the codebook corresponding to the G-RNTI, but may also be the codebook (such as Type-1 codebook) corresponding to the unicast PDSCH. That is, the bundling operation may be carried out on the bit in the codebook corresponding to the unicast PDSCH and the bit in the codebook corresponding to the G-RNTI to obtain the target codebook. Accordingly, a total number of bits in the codebook to be transmitted can be further reduced, and uplink overhead can be further reduced.

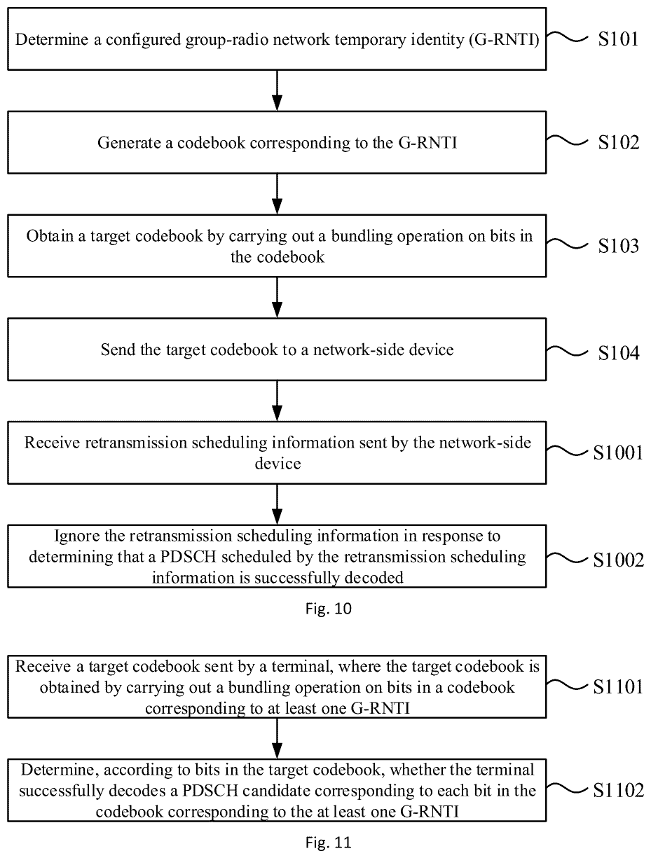

FIG. 10 is a schematic flow diagram of yet another codebook transmission method according to an example of the disclosure. As shown in FIG. 10, the method further includes:
S1001: Receive retransmission scheduling information sent by the network device.
S1002: Ignore the retransmission scheduling information in response to determining that a PDSCH scheduled by the retransmission scheduling information is successfully decoded.

In an example, after receiving the target codebook reported by the terminal, the network device may determine, according to bits in the codebook, whether the terminal successfully receives the PDSCH. The network device may retransmit a PDSCH that fails to be received (for instance, fails to be decoded). In order to enable the terminal to receive the retransmitted PDSCH, retransmission scheduling information is required to be sent first such that the terminal can determine a resource for receiving the retransmitted PDSCH.

However, since the target codebook reported by the terminal is obtained by carrying out a bundling operation on the codebook corresponding to the G-RNTI, although a total number of bits in the codebook is reduced, accuracy of indication is also reduced.

For instance, in cases of codebook 1, codebook 2 and codebook 3 mentioned above, first bits in codebook 1 and codebook 3 are 1. That is, the terminal successfully receives PDSCHs at the PDSCH candidates corresponding to the first bits in cases of G-RNTI1 and G-RNTI3.

However, since the second bit of codebook 2 is 0, and the first bit in the target codebook after the bundling operation is also 0, the network device will deem, according to the first bit in the target codebook, that the terminal does not successfully receive the PDSCH at the PDSCH candidate corresponding to the first bit in cases of G-RNTI1 and G-RNTI3, such that the PDSCH will be retransmitted. Moreover, scheduling information is transmitted to the terminal and a resource for retransmitting the PDSCH is indicated.

However, the terminal can determine that the PDSCH is successfully received at the PDSCH candidate corresponding to the first bit in cases of G-RNTI1 and G-RNTI3, such that when retransmission scheduling information of the PDSCH on the PDSCH candidate corresponding to the first bit in cases of G-RNTI1 and G-RNTI3 is received, the retransmission scheduling information can be ignored. Thus, the PDSCH successfully received is prevented from being repeatedly received, and the terminal will not combine a transmission block (TB) in the PDSCH retransmitted by the network device with a transmission block in the PDSCH successfully received and will not carry out decoding.

Retransmission scheduling information of the PDSCH on the PDSCH candidate corresponding to the first bit in G-RNTI2 can be normally parsed, and a corresponding retransmitted PDSCH is received.

FIG. 11 is a schematic flow diagram of a reception and determination method according to an example of the disclosure. The reception and determination method shown in the example may be performed by a network device. The network device may be in communication with a terminal. The network device includes but is not limited to a base station in a communication system, such as a 4G base station, a 5G base station and a 6G base station. The terminal includes but is not limited to a communication apparatus such as a mobile phone, a tablet computer, a wearable device, a sensor, and an internet of things device (such as an NB-IoT device, an MTC device and an eMTC device).

As shown in FIG. 11, the reception and determination method may include steps as follows:
S1101: Receive a target codebook sent by a terminal, where the target codebook is obtained by carrying out a bundling operation on bits in a codebook corresponding to at least one G-RNTI.
S1102: Determine, according to bits in the target codebook, whether the terminal successfully decodes a PDSCH candidate corresponding to each bit in the codebook corresponding to the at least one G-RNTI.

In an example, the network device may configure one or more G-RNTIs for the terminal. The terminal may generate a corresponding codebook according to each G-RNTI. The codebook may include a Type-1 codebook.

For instance, in a case that the terminal is configured with a plurality of G-RNTIs, the terminal generates a corresponding Type-1 codebook according to each G-RNTI such that a plurality of codebooks can be obtained. One codebook may include one or more bits, and 1 bit corresponds to one M_ac, where M_ac may represent a physical downlink shared channel (PDSCH) candidate. A bit corresponding to the PDSCH candidate may serve as hybrid automatic repeat request (HARQ) information configured to indicate whether the PDSCH candidate is successfully received (received and successfully decoded).

For instance, in a case that a value of the bit is 1, the bit is configured to indicate a hybrid automatic repeat request-acknowledgment (HARQ-ACK). In a case that the value of the bit is 0, the bit is configured to indicate a hybrid automatic repeat request-negative acknowledgment (HARQ-NACK).

It should be noted that a relation between the value and an indicated content of the bit can be adjusted according to requirements, which is not limited to the above cases. For instance, in a case that the value of the bit is 0, the bit may indicate the HARQ-ACK. In a case that the value of the bit is 1, the bit may indicate the HARQ-NACK. The following examples are illustratively described mainly in cases that the value of the bit is 1 and the bit indicates the HARQ-ACK, and the value of the bit is 0 and the bit indicates the HARQ-NACK.

In a case that the terminal is configured with a plurality of G-RNTIs, since a plurality of codebooks are required to be generated and uplink-sent to the network device, a large number of uplink resources are occupied. Moreover, excessive uplink overhead is likely to deteriorate a physical uplink control channel (PUCCH) performance.

According to examples of the disclosure, after determining the configured G-RNTI and generating a codebook corresponding to each G-RNTI, a terminal can obtain the target codebook (or referred to as a final codebook) by carrying out the bundling operation on the bits in the codebook, and then send the obtained target codebook to the network device.

By carrying out the bundling operation on the bits in the codebook, the obtained target codebook can include fewer bits than the codebook before the bundling operation. Thus, compared with transmitting a plurality of codebooks corresponding to a plurality of G-RNTIs to the network device, transmitting the target codebook to the network device can save uplink resources.

In an example, the bundling operation includes a logical AND operation.

The bundling operation may be carried out on bits in different codebooks, or may be carried out on different bits in the same codebook. For instance, the logical AND operation may be carried out on a plurality of bits subjected to the bundling operation. That is, an obtained result is 1 in a case that values of these bits are all 1 and is 0 as long as a value of any one of these bits is 0.

Through the logical AND operation, a value can be obtained according to values of a plurality of bits such that a number of bits in a target codebook finally obtained can be effectively reduced.

The network device may instruct the terminal to upload a codebook corresponding to each G-RNTI, or upload a target codebook obtained after the bundling operation.

In a case that the network device instructs the terminal to upload the target codebook obtained after the bundling operation, after the target codebook is received, it can be determined that the target codebook is obtained by carrying out the bundling operation on each G-RNTI. Thus, it can be determined, according to bits in the target codebook, whether the terminal successfully decodes a PDSCH candidate corresponding to each bit in a codebook corresponding to at least one G-RNTI (that is, G-RNTI corresponding to a codebook configured to generate the target codebook).

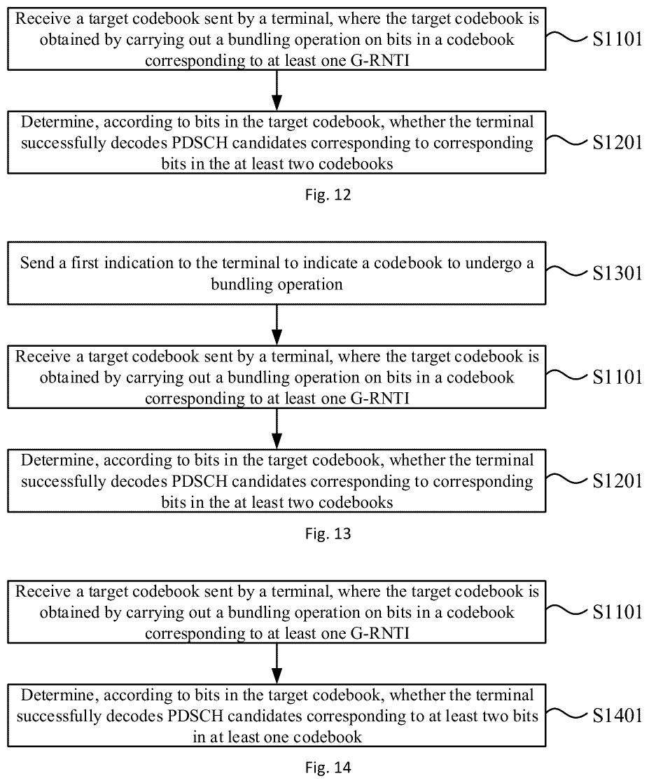

FIG. 12 is a schematic flow diagram of another reception and determination method according to an example of the disclosure. As shown in FIG. 12, the target codebook is obtained by carrying out a bundling operation on corresponding bits in at least two codebooks.

The step of determining, according to bits in the target codebook, whether the terminal successfully decodes a PDSCH candidate corresponding to each bit in the codebook corresponding to the at least one G-RNTI includes:
S1201: Determine, according to the bits in the target codebook, whether the terminal successfully decodes PDSCH candidates corresponding to corresponding bits in the at least two codebooks.

In an example, the network device may indicate a method for carrying out the bundling operation to the terminal. For instance, the bundling operation may be carried out through the method shown in FIG. 2B or through the method shown in FIG. 5B.

For instance, in a case that the terminal is instructed to carry out the bundling operation on corresponding bits in at least two codebooks and obtain a target codebook through the method shown in FIG. 2B, the network device determines, according to bits in the target codebook, whether the terminal successfully decodes PDSCH candidates corresponding to corresponding bits in the at least two codebooks.

FIG. 13 is a schematic flow diagram of yet another reception and determination method according to an example of the disclosure. As shown in FIG. 13, the method further includes:
S1301: Send a first indication to the terminal to indicate a codebook to undergo a bundling operation.

In an example, the network device may send a first indication to the terminal to indicate a codebook to undergo a bundling operation. For instance, the first indication sent to the terminal includes the G-RNTI corresponding to the codebook to undergo a bundling operation, such that the terminal determines that a bundling operation is required to be carried out on the codebook corresponding to the G-RNTI indicated by the first indication, and no bundling operation is carried out on codebooks corresponding to other G-RNTIs. Accordingly, the network device can flexibly control the bundling operation such that real-time requirements can be satisfied.

For instance, in cases of codebook 1, codebook 2 and codebook 3 mentioned above, the network device may instruct, by a first indication, the terminal to carry out a bundling operation on codebook 1 and codebook 2. The terminal may carry out a bundling operation on bits in codebook 1 and codebook 2 and obtain a target codebook, and then send the target codebook and codebook 3 to the network device.

FIG. 14 is a schematic flow diagram of yet another reception and determination method according to an example of the disclosure. As shown in FIG. 14, the target codebook is obtained by carrying out a bundling operation on at least two bits located in the same codebook, and the step of determining, according to bits in the target codebook, whether the terminal successfully decodes a PDSCH candidate corresponding to each bit in the codebook corresponding to the at least one G-RNTI includes:
S1401: Determine, according to the bits in the target codebook, whether the terminal successfully decodes PDSCH candidates corresponding to at least two bits in at least one codebook.

In an example, the network device may indicate a method for carrying out the bundling operation to the terminal. For instance, the bundling operation may be carried out through the method shown in FIG. 2B or through the method shown in FIG. 5B.

For instance, in a case that the terminal is instructed to carry out the bundling operation on at least two bits located in the same codebook and obtain a target codebook through the method shown in FIG. 5B, the network device determines, according to the bits in the target codebook, whether the terminal successfully decodes PDSCH candidates corresponding to the at least two bits in the at least one codebook.

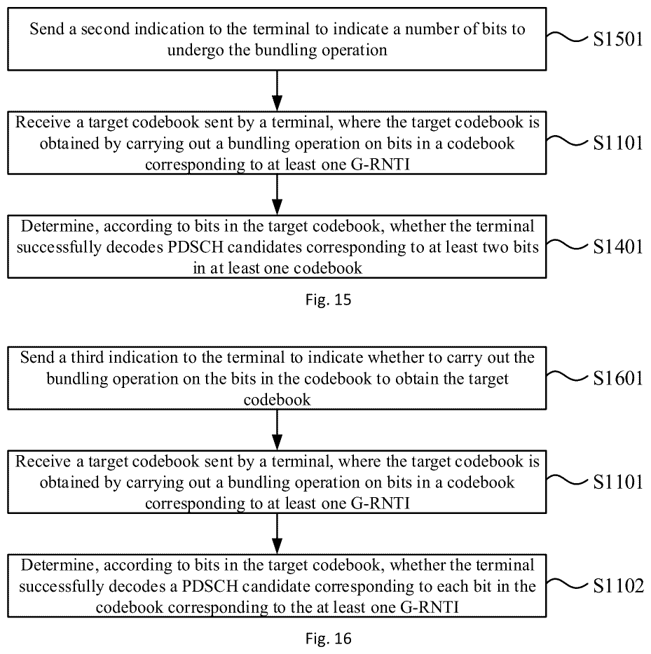

FIG. 15 is a schematic flow diagram of yet another reception and determination method according to an example of the disclosure. As shown in FIG. 15, the method further includes:
S1501: Send a second indication to the terminal to indicate a number of bits to undergo the bundling operation.

In an example, the network device may send a second indication to the terminal to indicate a number of bits to undergo a bundling operation, which can also be described as granularity. Thus, the terminal can determine a number of bits to undergo a bundling operation according to the indication of the network device. Accordingly, the network device can flexibly control the bundling operation such that real-time requirements can be satisfied.

For instance, if the second indication sent to the terminal indicates that a number of bits to undergo a bundling operation is 2, the terminal may carry out the bundling operation on bits in the codebook according to N=2 and an example shown in FIG. 5B.

For instance, if the second indication sent to the terminal indicates that a number of bits to undergo a bundling operation is 5, in a case of codebook 1 mentioned above, the bundling operation may be carried out on a 1st bit to a 5th bit, and an obtained value is 0. The bundling operation may be carried out on a 6th bit to a 10th bit, and an obtained value is 0. Thus, target codebook {00} corresponding to codebook 1 is obtained.

FIG. 16 is a schematic flow diagram of yet another reception and determination method according to an example of the disclosure. As shown in FIG. 16, the method further includes:
S1601: Send a third indication to the terminal to indicate whether to carry out the bundling operation on the bits in the codebook.

In an example, the network device may send a third indication to the terminal to control the terminal to enable or disable a function of carrying out a bundling operation on bits in the codebook. For instance, the third indication may be as shown in Table 1 above.

As shown in Table 1, the third indication may include 1 bit. In a case that a value of the bit is 0, the bit can instruct the terminal to disable the function of carrying out the bundling operation on the bits in the codebook. In a case that the value of the bit is 1, the bit can instruct the terminal to enable the function of carrying out the bundling operation on the bits in the codebook.

For instance, the network device instructs, by the third indication information, the terminal to enable the function of carrying out the bundling operation on the bits in the codebook. Then, the terminal may carry out the bundling operation on the bits in the codebook according to the above example, and send a target codebook obtained after the bundling operation to the network device.

For instance, the network device instructs, by the third indication information, the terminal to disable the function of carrying out the bundling operation on the bits in the codebook. Then, the terminal does not carry out the bundling operation on the bits in the codebook, but directly sends a codebook corresponding to each G-RNTI to the network device.

Accordingly, the network device can flexibly control whether the terminal carries out the bundling operation such that real-time requirements can be satisfied.

It should be noted that the third indication information may be carried in the same information as the first indication information in the above example, carried in the same information as the second indication information in the above example, or independently carried in one piece of information. Similarly, the first indication information and the second indication information may also be carried in the same information, or carried in different information. Information configured to carry the first indication information, the second indication information and the third indication information includes but is not limited to a radio resource control (RRC) signaling.

For instance, with a case that the first indication is carried in the RRC signaling as an instance, the RRC signaling may include 2 bits, and 4 cases may be indicated.

For instance, 00 indicates case 1 that a bundling operation is carried out on codebooks corresponding to G-RNTI1, G-RNTI2 and G-RNTI3;
01 indicates case 2 that a bundling operation is carried out on codebooks corresponding to G-RNTI1 and G-RNTI2;
10 indicates case 3 that a bundling operation is carried out on codebooks corresponding to G-RNTI1 and G-RNTI3; and
11 indicates case 4 that no bundling operation is executed on codebooks corresponding to different G-RNTIs. In this case, the terminal may carry out a bundling operation on at least two bits located in the same codebook to obtain a target codebook through a method shown in Example 5A mentioned above, or carry out no bundling operation Which operation specifically to be executed can be appointed according to requirements.

In an example, the target codebook is obtained by carrying out a bundling operation on the bits in the codebook corresponding to the G-RNTI and bits in a codebook corresponding to a unicast physical downlink shared channel (PDSCH).

The step of determining, according to bits in the target codebook, whether the terminal successfully decodes a PDSCH candidate corresponding to each bit in the codebook corresponding to the at least one G-RNTI includes:
determine, according to the bits in the target codebook, whether the terminal successfully decodes PDSCH candidates corresponding to the bits in the codebook corresponding to the G-RNTI and bits in a codebook corresponding to a unicast PDSCH.

In an example, the G-RNTI may be indicated to a terminal carrying out a multicast broadcast service (MBS). A bit in a Type-1 codebook corresponding to the G-RNTI may be configured to indicate whether an MBS PDSCH is successfully received.

The object subjected to the bundling operation in the example may not be limited to the codebook corresponding to the G-RNTI, but may also be the codebook (such as Type-1 codebook) corresponding to the unicast PDSCH. That is, the bundling operation may be carried out on the bit in the codebook corresponding to the unicast PDSCH and the bit in the codebook corresponding to the G-RNTI to obtain the target codebook. Accordingly, a total number of bits in the codebook to be transmitted can be further reduced, and uplink overhead can be further reduced.

In this case, the network device can determine, according to the bits in the target codebook, whether the terminal successfully decodes PDSCH candidates corresponding to the bits in the codebook corresponding to the G-RNTI and bits in a codebook corresponding to a unicast PDSCH.

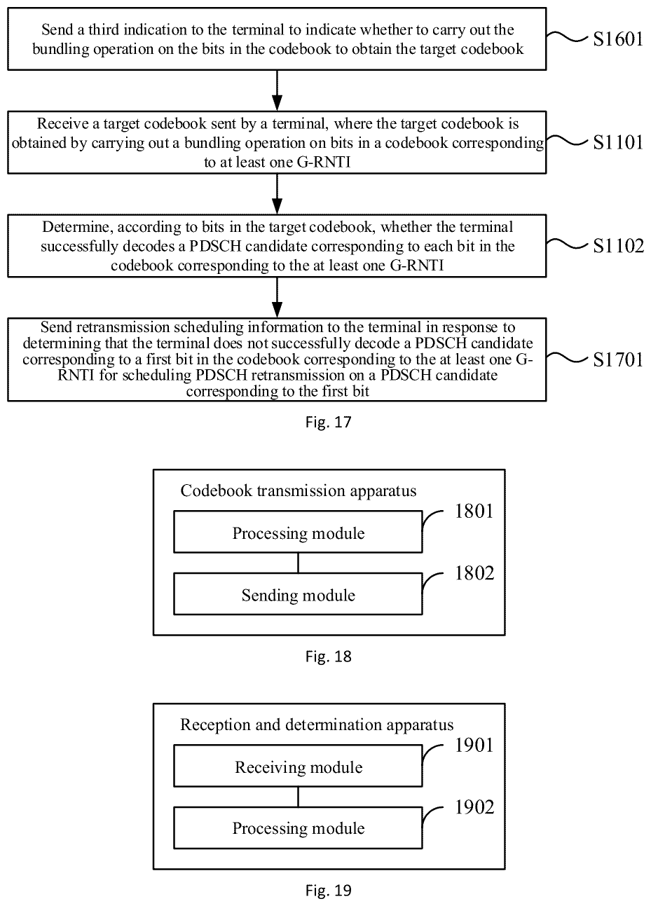

FIG. 17 is a schematic flow diagram of yet another reception and determination method according to an example of the disclosure. As shown in FIG. 17, the method further includes:
S1701: Send retransmission scheduling information to the terminal in response to determining that the terminal does not successfully decode a PDSCH candidate corresponding to a first bit in the codebook corresponding to the at least one G-RNTI for scheduling PDSCH retransmission on a PDSCH candidate corresponding to the first bit.

In an example, after receiving the target codebook reported by the terminal, the network device may determine, according to bits in the codebook, whether the terminal successfully receives the PDSCH. The network device may retransmit a PDSCH that fails to be received (for instance, fails to be decoded). In order to enable the terminal to receive the retransmitted PDSCH, retransmission scheduling information is required to be sent first such that the terminal can determine a resource for receiving the retransmitted PDSCH.

For instance, in response to determining that the terminal does not successfully decode a PDSCH candidate corresponding to a first bit in the codebook corresponding to the at least one G-RNTI, retransmission scheduling information is sent to the terminal for scheduling PDSCH retransmission on a PDSCH candidate corresponding to the first bit.

Corresponding to the foregoing examples of the codebook transmission method and the reception and determination method, the disclosure further provides examples of a codebook transmission apparatus and a reception and determination apparatus.

FIG. 18 is a schematic block diagram of a codebook transmission apparatus according to an example of the disclosure. The codebook transmission apparatus shown in the example may be performed by a terminal. The terminal includes but is not limited to a communication apparatus such as a mobile phone, a tablet computer, a wearable device, a sensor and an internet of things device (such as an NB-IoT device, an MTC device and an eMTC device). The terminal may be in communication with a network device. The network device includes but is not limited to a network device in a 4G, 5G, 6G and other communication systems, such as a base station and a core network.

As shown in FIG. 18, the codebook transmission apparatus may include:
a processing module 1801 configured to determine a configured group-radio network temporary identity (G-RNTI), generate a codebook corresponding to the G-RNTI, obtain a target codebook by carrying out a bundling operation on bits in the codebook; and
a sending module 1802 configured to send the target codebook to a network device. In an example, the bundling operation includes a logical AND operation.

In an example, the processing module is configured to obtain the target codebook by carrying out the bundling operation on corresponding bits in at least two codebooks.

In an example, the processing module is further configured to determine a first codebook including a greatest number of bits from the at least two codebooks; and
add, in response to determining that a second number of bits included in a second codebook of the at least two codebooks is different from the first number of the bits included in the first codebook, to the bits included in the second codebook according to the first number, where an added bit is configured to indicate a hybrid automatic repeat request-acknowledgment (HARQ-ACK).

In an example, the apparatus further includes:
a first receiving module configured to receive a first indication sent by the network device.

The processing module is further configured to determine, according to the first indication, a codebook to undergo the bundling operation.

In an example, the processing module is configured to obtain the target codebook by carrying out the bundling operation on at least two bits located in the same codebook.

In an example, the apparatus further includes:
a second receiving module configured to receive a second indication sent by the network device.

The processing module is further configured to determine, according to the second indication, a number of bits to undergo the bundling operation.

In an example, the apparatus further includes:
a third receiving module configured to receive a third indication sent by the network device.

The processing module is further configured to determine, according to the third indication, whether to carry out the bundling operation on the bits in the codebook.

In an example, the processing module is further configured to determine a codebook corresponding to a unicast PDSCH.

The processing module is configured to obtain the target codebook by carrying out the bundling operation on the bits in the codebook corresponding to the G-RNTI and bits in the codebook corresponding to the unicast PDSCH.

In an example, the apparatus further includes:
a fourth receiving module configured to receive retransmission scheduling information sent by the network device.

The processing module is further configured to ignore the retransmission scheduling information in response to determining that a PDSCH scheduled by the retransmission scheduling information is successfully decoded.

FIG. 19 is a schematic block diagram of a reception and determination apparatus according to an example of the disclosure. The reception and determination apparatus shown in the example may be performed by a network device. The network device may be in communication with a terminal. The network device includes but is not limited to a base station in a communication system, such as a 4G base station, a 5G base station and a 6G base station. The terminal includes but is not limited to a communication apparatus such as a mobile phone, a tablet computer, a wearable device, a sensor, and an internet of things device (such as an NB-IoT device, an MTC device and an eMTC device).

As shown in FIG. 19, the reception and determination apparatus may include:
a receiving module 1901 configured to receive a target codebook sent by a terminal, where the target codebook is obtained by carrying out a bundling operation on bits in a codebook corresponding to at least one G-RNTI; and
a processing module 1902 configured to determine, according to bits in the target codebook, whether the terminal successfully decodes a PDSCH candidate corresponding to each bit in the codebook corresponding to the at least one G-RNTI.

In an example, the bundling operation includes a logical AND operation.

In an example, the target codebook is obtained by carrying out a bundling operation on corresponding bits in at least two codebooks.

The processing module is configured to determine, according to bits in the target codebook, whether the terminal successfully decodes PDSCH candidates corresponding to corresponding bits in the at least two codebooks.

In an example, the apparatus further includes:
a first sending module configured to send a first indication to the terminal to indicate a codebook to undergo a bundling operation.

In an example, the target codebook is obtained by carrying out a bundling operation on at least two bits located in the same codebook, and

The processing module is configured to determine, according to bits in the target codebook, whether the terminal successfully decodes PDSCH candidates corresponding to at least two bits in at least one codebook.

In an example, the apparatus further includes:
a second sending module configured to send a second indication to the terminal to indicate a number of bits to undergo the bundling operation.

In an example, the apparatus further includes:
a third sending module configured to send a third indication to the terminal to indicate whether to carry out the bundling operation on the bits in the codebook.

In an example, the target codebook is obtained by carrying out a bundling operation on the bits in the codebook corresponding to the G-RNTI and bits in a codebook corresponding to a unicast physical downlink shared channel (PDSCH).

The processing module is configured to determine, according to bits in the target codebook, whether the terminal successfully decodes PDSCH candidates corresponding to the bits in the codebook corresponding to the G-RNTI and bits in a codebook corresponding to a unicast PDSCH.

In an example, the apparatus further includes:
a forth sending module configured to send retransmission scheduling information to the terminal in response to determining that the terminal does not successfully decode a PDSCH candidate corresponding to a first bit in the codebook corresponding to the at least one G-RNTI for scheduling PDSCH retransmission on a PDSCH candidate corresponding to the first bit.

A specific method for executing an operation by each module of the apparatus in the above example is described in detail in the example of the related method, and will not be described in detail here.

Since the apparatus example substantially corresponds to the method example, reference can be made to part of the description of the method example for the related parts. The apparatus example described above is merely schematic, modules described as separate components can be physically separated or not, and components displayed as modules can be physical units or not. That is, the components can be located at one place, or distributed at a plurality of network modules. Some or all of modules can be selected according to actual requirements to achieve the objective of the solution of the example. Those of ordinary skill in the art can understand and implement the disclosure without making creative efforts.

An example of the disclosure further provides a communication apparatus. The communication apparatus includes: a processor; and a memory configured to store a computer program. When the computer program is executed by the processor, the codebook transmission method mentioned in any one of the above examples is implemented.

An example of the disclosure further provides a communication apparatus. The communication apparatus includes: a processor; and a memory configured to store a computer program. When the computer program is executed by the processor, the reception and determination method mentioned in any one of the above examples is implemented.

An example of the disclosure further provides a computer-readable storage medium. The computer-readable storage medium is configured to store a computer program. When the computer program is executed by a processor, steps of the codebook transmission method mentioned in any one of the above examples are implemented.

An example of the disclosure further provides a computer-readable storage medium. The computer-readable storage medium is configured to store a computer program. When the computer program is executed by a processor, steps of the reception and determination method mentioned in any one of the above examples are implemented.

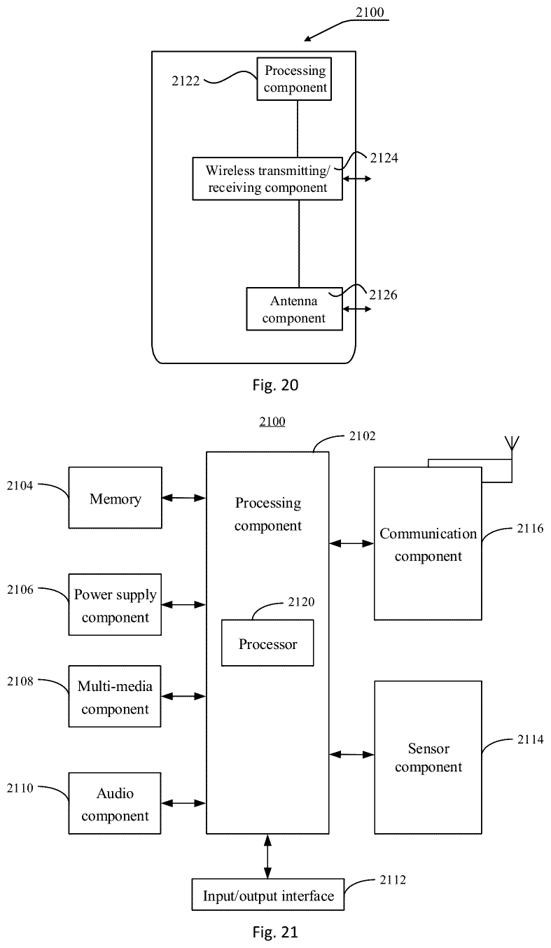

As shown in FIG. 20, FIG. 20 is a schematic block diagram of an apparatus 2000 for reception and determination according to an example of the disclosure. The apparatus 2000 may be provided as a base station. With reference to FIG. 20, the apparatus 2000 includes a processing component 2022, a wireless transmitting/receiving component 2024, an antenna component 2026, and a signal processing portion specific to a wireless interface. The processing component 2022 may further include one or more processors. One of the processors of the processing component 2022 may be configured to implement the reception and determination method mentioned in any one of the above examples.

FIG. 21 is a schematic block diagram of an apparatus 2100 for codebook transmission according to an example of the disclosure. For instance, the apparatus 2100 may be a mobile phone, a computer, a digital broadcasting terminal, a message receiving and transmitting device, a game console, a tablet device, a medical device, a fitness device, a personal digital assistant, etc.

With reference to FIG. 21, the apparatus 2100 may include one or more of components as follows: a processing component 2102, a memory 2104, a power supply component 2106, a multi-media component 2108, an audio component 2110, an input/output (I/O) interface 2112, a sensor component 2114 and a communication component 2116.

The processing component 2102 generally controls overall operations of the apparatus 2100, such as operations associated with display, telephone call, data communication, camera operations and recording operations. The processing component 2102 may include one or more processors 2120 to execute an instruction, so as to complete all or some steps of the above codebook transmission method. In addition, the processing component 2102 may include one or more modules such that the processing component 2102 can interact with other components. For instance, the processing component 2102 may include a multi-media module such that the multi-media component 2108 can interact with the processing component 2102.

The memory 2104 is configured to store various types of data to support operations at the apparatus 2100. Instances of such data include instructions configured for any application or method operating on the apparatus 2100, contact data, phonebook data, messages, pictures and video etc. The memory 2104 may be implemented by any type of volatile or non-volatile storage devices or their combinations, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 2106 provides power for various components of the apparatus 2100. The power supply component 2106 may include a power supply management system, one or more power supplies, and other components associated with generation, management and power distribution of the apparatus 2100.

The multi-media component 2108 includes a screen that provides an output interface between the apparatus 2100 and a user. In some examples, the screen may include a liquid crystal display (LCD) and a touch panel (TP). If the screen includes a touch panel, the screen can be implemented as a touch screen to receive an input signal from a user. The touch panel includes one or more touch sensors to sense a touch, a swipe and a gesture on the touch panel. The touch sensor can not only sense a boundary of a touch or a swipe, but also measure duration and pressure associated with the touch or the swipe. In some examples, the multi-media component 2108 includes a front-facing camera and/or a rear-facing camera. When the apparatus 2100 is in an operating mode, such as a photographing mode or a video mode, the front-facing camera and/or the rear-facing camera can receive external multi-media data. Each of the front-facing camera and the rear-facing camera may be a fixed optical lens system or have focusing and optical zooming capabilities.

The audio component 2110 is configured to output and/or input an audio signal. For instance, the audio component 2110 includes a microphone (MIC). When the apparatus 2100 is in an operating mode, such as a call mode, a recording mode or a voice recognition mode, the microphone is configured to receive an external audio signal. The received audio signal may be further stored in the memory 2104 or transmitted by the communication component 2116. In some examples, the audio component 2110 further includes a loudspeaker configured to output an audio signal.

The I/O interface 2112 provides an interface between the processing component 2102 and peripheral interface modules, such as keyboards, click wheels and buttons. These buttons may include but are not limited to a home button, a volume button, a start button and a lock button.

The sensor component 2114 includes one or more sensors, which are configured to provide state assessment of various aspects for the apparatus 2100. For instance, the sensor component 2114 may detect a startup/shutdown state of the apparatus 2100, and relative positioning of components, which are a display and a keypad of the apparatus 2100 for instance. The sensor component 2114 may further detect a position change of the apparatus 2100 or a component of the apparatus 2100, presence or absence of a touch between a user and the apparatus 2100, an orientation or acceleration/deceleration of the apparatus 2100, and a temperature change of the apparatus 2100. The sensor component 2114 may include a proximity sensor configured to detect the presence of a nearby object in the absence of any physical touch. The sensor component 2114 may further include a light sensor, such as a complementary metal oxide semiconductor (CMOS) or charge coupled device (CCD) image sensor, which are configured to be used in imaging applications. In some examples, this sensor component 2114 may further include an acceleration sensor, a gyroscopic sensor, a magnetic sensor, a pressure sensor or a temperature sensor.

The communication component 2116 is configured to facilitate wired or wireless communication between the apparatus 2100 and other devices. The apparatus 2100 may access a wireless network based on a communication standard, such as Wi-Fi, 2G, 3G, 4G long term evolution (LTE), 5G new radio (NR) or their combinations. In an example, the communication component 2116 receives a broadcast signal or broadcast related information from an external broadcast management system by a broadcast channel. In an example, the communication component 2116 further includes a near-field communication (NFC) module to promote short-range communication. For instance, the NFC module may be implemented based on a radio frequency identification (RFID) technology, an infrared data association (IrDA) technology, an ultra wideband (UWB) technology, a Bluetooth (BT) technology and other technologies.

In an example, the apparatus 2100 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors or other electronic elements, and is configured to execute the above codebook transmission method.

In an example, a non-transitory computer-readable storage medium including an instruction is further provided, such as a memory 2104 including an instruction. The above instruction may be executed by the processor 2120 of the apparatus 2100, so as to complete the above codebook transmission method. For instance, the non-transitory computer-readable storage medium may be an ROM, a random access memory (RAM), a compact disc read-only memory (CD-ROM), a magnetic tape, a floppy disk, an optical data storage device, etc.

Those skilled in the art could easily conceive of other implementation solutions of the disclosure upon consideration of the description and the disclosure disclosed in the implementations. The disclosure is intended to encompass any variations, uses or adaptive changes of the disclosure, which follow the general principles of the disclosure and include common general knowledge or customary technical means, which is not disclosed in the disclosure, in the art. The description and examples are regarded as exemplary merely.

It should be understood that the disclosure is not limited to a precise structure described above and shown in accompanying drawings, and can have various modifications and changes without departing from the scope of the disclosure.

It should be noted that relational terms such as “first” and “second” here are merely configured to distinguish one entity or operation from another entity or operation without certainly requiring or implying any such actual relation or order between such entities or operations. Terms “comprise,” “include” or their any other variations are intended to encompass non-exclusive inclusions, such that a process, method, article or device including a series of elements not only includes those elements, but also includes other elements that are not explicitly listed, or also includes inherent elements of such process, method, article or device. Under the circumstance of no more limitations, an element limited by sentence “including a . . . ” or “comprising a . . . ” does not exclude that there are other same elements in a process, a method, an article or a device including the element.

Methods and apparatuses provided in examples of the disclosure are described in detail above, specific instances are used here for illustrating the principles and implementations of the disclosure, and the description of the foregoing examples is merely used for helping in understanding the method of the disclosure and core ideas of the disclosure. Moreover, those of ordinary skill in the art can make changes in terms of particular embodiments and the scope of application in accordance with the ideas of the disclosure. In conclusion, the content of the description should not be understood as limiting the disclosure.

1. A method for codebook transmission, performed by a terminal, the method comprising:
determining a configured group-radio network temporary identity (G-RNTI);
generating a codebook corresponding to the G-RNTI;
obtaining a target codebook by carrying out a bundling operation according to bits in the codebook corresponding to the G-RNTI; and
sending the target codebook to a network device.

2. The method according to claim 1, wherein the bundling operation comprises a logical AND operation.

3. The method according to claim 1, wherein the obtaining the target codebook by carrying out the bundling operation according to bits in the codebook corresponding to the G-RNTI comprises:
obtaining the target codebook by carrying out a bundling operation on corresponding bits in at least two of the codebooks.

4. The method according to claim 3, further comprising:
determining, in response to different numbers of bits comprised in at least two of the codebooks, a first codebook comprising a greatest number of bits; and
adding to bits comprised in other codebooks according to a number of bits in the first codebook, wherein an added bit is configured to indicate a hybrid automatic repeat request-acknowledgment (HARQ-ACK).

5. The method according to claim 3, further comprising:
receiving a first indication sent by the network device; and
determining, according to the first indication, a codebook to undergo the bundling operation in the codebook corresponding to the G-RNTI.

6. The method according to claim 1, wherein the obtaining the target codebook by carrying out the bundling operation according to bits in the codebook corresponding to the G-RNTI comprises:
obtaining the target codebook by carrying out a bundling operation on at least two bits located in the same codebook.

7. The method according to claim 6, further comprising:
receiving a second indication sent by the network device; and
determining, according to the second indication, a number of bits to undergo the bundling operation.

8. The method according to claim 1, further comprising:
receiving a third indication sent by the network device; and
determining, according to the third indication, whether to carry out the bundling operation on the bits in the codebook.

9. The method according to claim 1, further comprising:
determining a codebook corresponding to a unicast physical downlink shared channel (PDSCH); wherein
the obtaining the target codebook by carrying out the bundling operation according to bits in the codebook corresponding to the G-RNTI comprises:
obtaining the target codebook by carrying out a bundling operation on bits in the codebook corresponding to the G-RNTI and bits in the codebook corresponding to the unicast PDSCH.

10. The method according to claim 1, further comprising:
receiving retransmission scheduling information sent by the network device; and
ignoring the retransmission scheduling information in response to determining that a PDSCH scheduled by the retransmission scheduling information is successfully decoded.

11. A method for reception and determination, performed by a network device, the method comprising:
receiving a target codebook sent by a terminal, wherein the target codebook is obtained by carrying out a bundling operation according to bits in a codebook corresponding to at least one G-RNTI; and
determining, according to bits in the target codebook, whether the terminal successfully decodes a PDSCH candidate corresponding to each bit in the codebook corresponding to the at least one G-RNTI.

12. The method according to claim 11, wherein the bundling operation comprises a logical AND operation.

13. The method according to claim 12, wherein the target codebook is obtained by carrying out a bundling operation on corresponding bits in at least two codebooks; and
the determining, according to bits in the target codebook, whether the terminal successfully decodes the PDSCH candidate corresponding to each bit in the codebook corresponding to the at least one G-RNTI comprises:
determining, according to the bits in the target codebook, whether the terminal successfully decodes PDSCH candidates corresponding to corresponding bits in the at least two codebooks.

14. (canceled)

15. The method according to claim 12, wherein the target codebook is obtained by carrying out a bundling operation on at least two bits located in the same codebook, and
the determining, according to bits in the target codebook, whether the terminal successfully decodes the PDSCH candidate corresponding to each bit in the codebook corresponding to the at least one G-RNTI comprises:
determining, according to the bits in the target codebook, whether the terminal successfully decodes PDSCH candidates corresponding to at least two bits in at least one codebook.

16. (canceled)

17. (canceled)

18. The method according to claim 11, wherein the target codebook is obtained by carrying out a bundling operation on the bits in the codebook corresponding to the G-RNTI and bits in a codebook corresponding to a unicast physical downlink shared channel (PDSCH); and
the determining, according to bits in the target codebook, whether the terminal successfully decodes the PDSCH candidate corresponding to each bit in the codebook corresponding to the at least one G-RNTI comprises:
determining, according to the bits in the target codebook, whether the terminal successfully decodes PDSCH candidates corresponding to the bits in the codebook corresponding to the G-RNTI and bits in a codebook corresponding to the unicast PDSCH.

19. The method according to claim 11, further comprising:
sending retransmission scheduling information to the terminal in response to determining that the terminal does not successfully decode a PDSCH candidate corresponding to a first bit in the codebook corresponding to the at least one G-RNTI for scheduling PDSCH retransmission on the PDSCH candidate corresponding to the first bit.

20. (canceled)

21. (canceled)

22. A communication apparatus, comprising:
one or more processors and a memory, and the one or more processors are collectively configured to:
determine a configured group-radio network temporary identity (G-RNTI);
generate a codebook corresponding to the G-RNTI;
obtain a target codebook by carrying out a bundling operation according to bits in the codebook corresponding to the G-RNTI; and
send the target codebook to a network device.

23. A communication apparatus, comprising:
one or more processors; and
a memory configured to store a computer program; wherein
when the computer program is executed by the one or more processors, the communication apparatus performs the reception and determination method according to claim 11.

24. A non-transitory computer-readable storage medium, storing a computer program, wherein when the computer program is executed by one or more processors, the one or more processors collectively perform the method according to claim 1.

25. A non-transitory computer-readable storage medium, storing a computer program, wherein when the computer program is executed by one or more processors, the one or more processors collectively perform the method according to claim 11.
